(19) United States
(12) Patent Application Publication
(10) Pub. No.: US 2013/0164553 A1
(43) Pub. Date: Jun. 27, 2013

(54) COPPER POWDER, COPPER PASTE AND METHOD FOR PREPARING COPPER POWDER

(71) Applicant: Samsung Electro-Mechanics Co., Ltd., Suwon (KR)

(72) Inventors: Kwi Jong LEE, Suwon (KR); Young Il Lee, Anyang (KR); Ji Han Kwon, Namyangju (KR); Dong Hoon Kim, Seongnam (KR)

(73) Assignee: SAMSUNG ELECTRO-MECHANICS CO., LTD., Suwon-si (KR)

(21) Appl. No.: 13/721,343

(22) Filed: Dec. 20, 2012

(30) Foreign Application Priority Data
Dec. 27, 2011 (KR) 10-2011-0143416

(51) Int. Cl. H01B 1/02; H01B 13/00

(52) U.S. Cl. CPC H01B 1/026; H01B 13/00
USPC 428/570; 148/282

(57) ABSTRACT

Disclosed herein are copper powder, a copper paste and a method for preparing a copper powder. The copper powder is provided with a cuprous oxide film having a loose structure on a surface of the copper powder, thereby preventing the copper particles from being naturally oxidized, making it possible to being subjected to a low temperature firing process and having improved conductivity.

### CROSS REFERENCE(S) TO RELATED APPLICATIONS

This application claims the benefit under 35 U.S.C. Section 119 of Korean Patent Application Serial No. 10-2011-0143416, entitled “Copper Powder, Copper Paste and Method for Preparing Copper Powder” filed on Dec. 27, 2011, which is hereby incorporated by reference in its entirety into this application.

### BACKGROUND OF THE INVENTION

1. Technical Field

The present invention relates to a copper powder, a copper paste and a method for preparing a copper powder.

2. Description of the Related Art

Copper has a specific resistance value similar to that of silver, but the material costs thereof are much less than silver, such that copper is currently used for electric wiring of most electronic components.

In the case of forming a copper paste using a copper powder, the copper powder is naturally oxidized or oxidized at the time of heat treatment during a sintering process, or the like, such that conductivity thereof is deteriorated.

Meanwhile, a technology of forming a paste using a nano-sized copper particle and forming a conductive pattern using the paste has been suggested.

As an example, Patent Document 1 discloses a technology in which a paste including nano-sized copper particles is sintered at about 350° C. to form a copper metal wiring.

In general, as a sintering temperature increases, oxidation of a metal is intensified, such that conductivity is reduced.

In order to overcome the reduction in conductivity at the time of the high sintering process as described above, Patent Document 2 discloses a technology of coating a surface of the copper particle with silver so as to lower the sintering temperature of the copper particle. However, additional preparing processes of coating silver are added, and material costs are increased.

### SUMMARY OF THE INVENTION

An object of the present invention is to provide a copper powder capable of being subjected to a low temperature sintering process and having improved conductivity after the sintering process.

Another object of the present invention is to provide a method for preparing the copper powder.

Another object of the present invention is to provide a copper paste including the copper powder.

According to an exemplary embodiment of the present invention, there is provided a copper powder including: a copper particle and a cuprous oxide film formed on a surface of the copper particle.

The copper powder may have a diameter of 0.1 to 10 μm, and the cuprous oxide film may have 5 to 20 wt % based on the weight of the copper powder.

The cuprous oxide film may have a thickness which is 2 to 10% diameter of the copper powder.

According to an exemplary embodiment of the present invention, there is provided a cuprous copper film sealing an overall surface of the copper particle so as to block it from external air.

According to an exemplary embodiment of the present invention, there is provided a copper paste including: a copper powder having a cuprous oxide film formed on a surface of a copper particle, a binder, and a solvent.

According to another exemplary embodiment of the present invention, there is provided a method for preparing a copper powder including: preparing a first solution by putting copper particles into aqueous alkaline solution, followed by stirring; preparing a second solution by putting fatty acid into the first solution; and forming the cuprous oxide film on the surface of each of the copper particles by isolating and purifying the copper particles from the second solution and then leaving the copper particles in the air.

The copper powder may have a diameter of 0.1 to 10 μm.

In addition, the cuprous oxide film may have 5 to 20 wt % based on the weight of the copper powder.

In addition, in the forming of the cuprous oxide film, the cuprous oxide film may have a thickness which is 2 to 10% the diameter of the copper powder.

According to still another exemplary embodiment of the present invention, there is provided a method for preparing a copper powder including: preparing a first solution by putting copper particles into an aqueous alkaline solution, followed by stirring; preparing a second solution by putting fatty acid into the first solution; and forming a cuprous oxide film sealing an overall surface of each of the copper particles so as to block it from external air by isolating and purifying the copper particles from the second solution and then leaving the copper particles in the air.

### BRIEF DESCRIPTION OF THE DRAWINGS

FIG. 1 is a view schematically showing a cross-sectional structure of a copper powder according to an exemplary embodiment of the present invention;

FIG. 2 is a view showing X-ray diffraction pattern of the copper powder according to the exemplary embodiment of the present invention;

FIG. 3 is a view showing a weight change according to the temperature at the time of heating the copper powder according to the exemplary embodiment of the present invention; and

FIG. 4 is a flow chart showing a method for preparing the copper powder according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

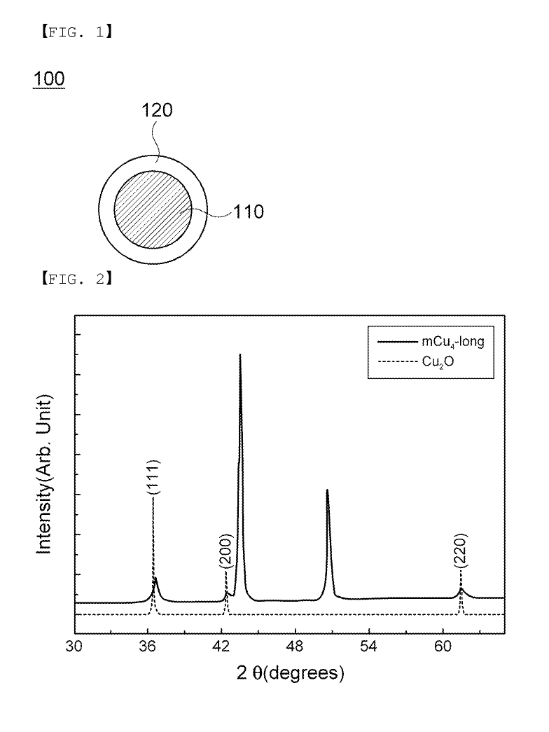

FIG. 1 is a view schematically showing a cross-sectional structure of a copper powder according to an exemplary embodiment of the present invention.

Referring to FIG. 1, copper powder 100 according to the exemplary embodiment of the present invention may include a cuprous oxide film 120 formed on a surface of a copper particle 110 and made of cuprous oxide (Cu₂O).

In this case, the cuprous copper film 120 preferably seals an overall surface of each of the copper particles so as to block it from external air.

Meanwhile, the copper powder may have a diameter of 0.1 to 10 μm.

When the diameter thereof is excessively small, all of the copper powder becomes oxidized.

When the diameter thereof is excessively large, a surface treatment effect is insufficient, such that the diameter within a range as described above is preferred.

In addition, the cuprous oxide film may have a weight of 5 to 20 Wt % based on the weight of the copper powder.

When the content of the cuprous oxide film is excessively small, the surface treatment effect is insufficient.

When the content thereof is excessively large, it has a problem in re-reduction, such that the content within a range as described above is preferred.

In general, in the case in which the copper particle is left in the air as it is, oxygen in the air reacts with the surface of the copper particle, such that the copper particle is continuously oxidized.

In the case of this natural oxidation, the oxide film is relatively slowly formed. The oxide film thus formed has a large density and a tight structure, such that, at the time of firing the copper powder, the oxide film is not rapidly reduced and remains on the surface of the copper particles to thereby increase resistance of the conductive pattern formed by the firing process.

However, the copper powder 100 according to the exemplary embodiment of the present invention includes the cuprous oxide film 120 formed on the surface of the copper particle 110. The cuprous oxide film 120 has a small density and a loose structure as compared to the naturally formed oxide film, such that it is rapidly reduced during the firing process to thereby make it possible to being subject to the low temperature firing process.

In addition, the cuprous oxide film 120 serves to block oxygen in the air, such that an overall surface of the copper particle 110 is not more reacted with the oxygen in the air, thereby making it possible to prevent or reduce additionally natural oxidization of the copper powder.

FIG. 2 is a view showing X-ray diffraction pattern of the copper powder according to the exemplary embodiment of the present invention.

Referring to FIG. 2, when analyzing X-ray diffraction pattern of the copper powder according to the exemplary embodiment of the present invention, it can be appreciated that crystalline peaks of copper (mCu₄-long) and crystalline peaks of cuprous oxide (Cu₂O) are shown together (111, 200, 220). Therefore, the cuprous oxide (Cu₂O) film is formed in the copper powder by treating the surface thereof.

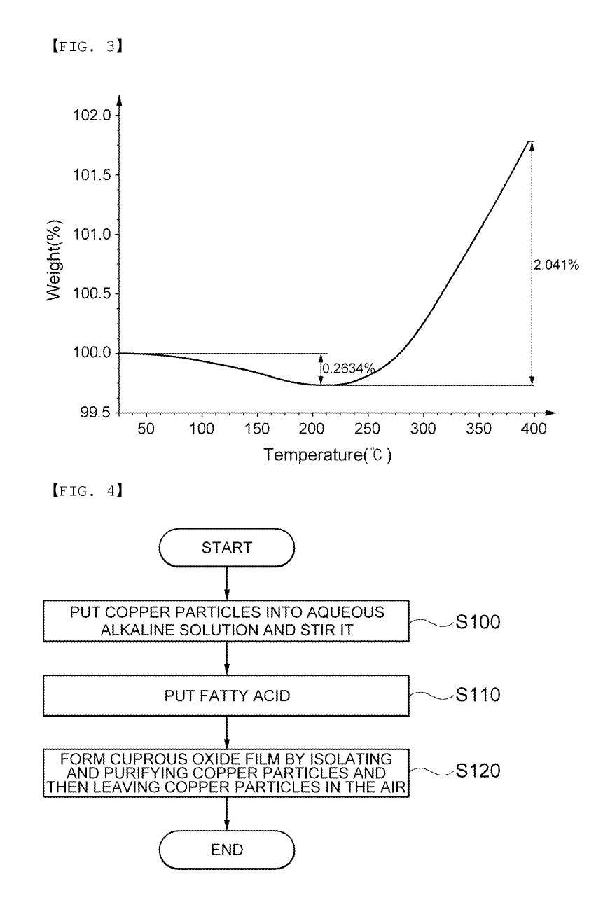

FIG. 3 is a view showing a weight change according to a temperature at the time of heating the copper powder according to the exemplary embodiment of the present invention.

Referring to FIG. 3, weight of the copper powder according to the exemplary embodiment of the present invention is reduced by about 210□ and after that, the weight thereof is again increased.

At the beginning of heating, the cuprous oxide film of the surface of the copper powder is reduced, such that the weight of the copper powder is reduced. When the temperature is increased over about 210□, the cuprous oxide film is completely reduced and then it is again oxidized, such that the weight thereof is increased. Therefore, as shown in FIG. 3, a weight change is confirmed.

That is, when a copper paste made of the copper powder according to the exemplary embodiment of the present invention is printed as a conductive pattern and then is fired, all of the cuprous oxide film of the surface of the copper powder is reduced at around 210□ to connect between copper particles to thereby form the conductive pattern, such that resistivity of the conductive pattern may be remarkably lowered as compared to that of the prior art.

After the conductivity pattern is formed as described above, although it is again oxidized, only an external surface of the conductive pattern is oxidized, such that the resistivity thereof is not lowered.

FIG. 4 is a flow chart showing a method for preparing the copper powder according to the embodiment of the present invention.

Referring to FIG. 4, the method for preparing the copper powder according to the exemplary embodiment of the present invention may include preparing a first solution by putting copper particle into an aqueous alkaline solution, followed by stirring (S100); preparing a second solution by putting fatty acid into the first solution (S110); and forming a cuprous oxide film on the surface of each of copper particles by isolating and purifying the copper particles from the second solution and then leaving the copper particles in the air (S120).

First, when the copper particles are put into the aqueous alkaline solution and is stirred, the surface of the copper particle has alkaline, such that the copper particles may be stirred while being well-dispersed (S100).

Then, when fatty acid is put into the solution where the copper particles are well-dispersed, a kind of defectors are combined to each other on the surface of each of the copper particles in the aqueous solution, resulting in coagulation of the copper particles (S110).

In this case, formic acid, acetic acid, butanoic acid, octanoic acid, dodecanoic acid, octadecanoic acid, oleic acid, or the like, may be used as the fatty acid.

And then, when isolating and purifying the copper particles and then leaving them in the air, surface oxidation proceeds to form the cuprous oxide film on the surface thereof. (S120)

The defectors as described above rapidly serve to allow oxygen in the air to react with the surface of the copper particles, thereby forming the cuprous oxide film.

Meanwhile, in order that the cuprous oxide film prevents natural oxidation of the copper particles and, at the time of firing, it is smoothly reduced to form the conductive pattern, the weight ratio of the cuprous oxide to the copper powder, a thickness, an average density, or the like of the cuprous oxide film needs to be implemented within the proper ranges as described above.

Therefore, in order that the cuprous oxide film has a weight of 5 to 20 wt % based on the weight of the copper powder, substitution reaction needs to be processed at a temperature of 50□ or less and drying also needs to be processed at room temperature.

In addition, in the forming of the cuprous oxide film, the cuprous oxide film needs to have a thickness which is 2 to 10% diameter of the copper powder.

Meanwhile, the copper paste may be prepared by mixing a binder, a solvent and an additive in the copper powder.

### EXPERIMENTAL EXAMPLE 1

A copper paste was prepared by mixing a copper powder according to exemplary embodiment of the present invention with a binder, a solvent and an additive. A screening printing process using the prepared copper paste was performed to print a conductive pattern having a line width of 100 μm and a line length of 6 cm on a transparent conductive oxide (TCO) layer, followed by sintering for 1 hour at 200□ under nitrogen atmosphere and reduction atmosphere and then the resistance thereof was measured.

TABLE 1

| | Nitrogen atmosphere | Reduction atmosphere |
|---|---|---|
| Classification | (Ω) | (Ω) |
| General copper powder | Cannot be measured | 16.3 |
| Copper powder | 130 | 6.4 |
| according to exemplary | | |
| embodiment of the | | |
| present invention. | | |

<Table 1>Comparison of Resistivity of Conductive Pattern

Referring to Table 1, it may be appreciated that the copper powder according to the exemplary embodiment of the present invention secures conductivity even in the case of firing it under the nitrogen atmosphere and the conductive pattern is formed to have lower resistivity of about 60% or below as compared to the resistivity in the case of using the general copper powder of the related art.

TABLE 2

| Classification | Resistivity value(uΩ · cm) |
|---|---|
| General copper powder | 302 |
| Copper powder oxidized in high temperature | 265 |
| and high humidity | |
| Copper powder treated with fatty acid | 25 |
| containing one carbon | |
| Copper powder treated with fatty acid | 27 |
| containing 4 carbons | |
| Copper powder treated with fatty acid | 31 |
| containing 18 carbon | |

<Table 2>Resistivity Value According to Surface Treatment

Referring to Table 2, it may be appreciated that as general copper powder is naturally oxidized, the resistivity value is the largest at the time of forming the conductive pattern, and the copper powder oxidized in high temperature and high humidity has a relatively reduced resistivity value as compared to the copper powder naturally oxidized.

However, it may be appreciated that the copper powder having the surface treated with fatty acid containing 1 or 4 or 18 carbons according to the exemplary embodiment of the present invention has resistivity which is reduced to 1/10 as compared to the general copper powder.

According to an exemplary embodiment of the present invention, the copper powder has the cuprous oxide film having large reducibility and formed on the surface of the copper powder, thereby preventing the copper particles from being additionally naturally oxidized, making it possible to being subjected to a firing process below 300□ under reduction atmosphere, and having improved conductivity after the sintering process as compared to that of the related art.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A copper powder comprising
a copper particle and a cuprous oxide film formed on a surface of the copper particle.

2. The copper powder according to claim 1, wherein the copper powder has a diameter of 0.1 to 10 μm, and
the cuprous oxide film has 5 to 20 wt % based on the weight of the copper powder.

3. The copper powder according to claim 1, wherein the cuprous oxide film has a thickness which is 2 to 10% the diameter of the copper powder.

4. A copper powder comprising
a cuprous copper film sealing an overall surface of the copper particle so as to block it from external air.

5. A copper paste comprising a copper powder having a cuprous oxide film formed on a surface of a copper particle, a binder, and a solvent.

6. A method for preparing a copper powder comprising:
preparing a first solution by putting copper particles into aqueous alkaline solution, followed by stirring;
preparing a second solution by putting fatty acid into the first solution; and
forming a cuprous oxide film on a surface of each of the copper particles by isolating and purifying the copper particles from the second solution and then leaving the copper particles in the air.

7. The method according to claim 6, wherein the copper powder has a diameter of 0.1 to 10 μm.

8. The method according to claim 6, wherein the cuprous oxide film has 5 to 20 wt % based on the weight of the copper powder.

9. The method according to claim 6, wherein in the forming of the cuprous oxide film, the cuprous oxide film has a thickness which is 2 to 10% the diameter of the copper powder.

10. A method of preparing a copper powder comprising:
preparing a first solution by putting copper particles into an aqueous alkaline solution, followed by stirring;
preparing a second solution by putting fatty acid into the first solution; and
forming a cuprous oxide film sealing an overall surface of each of the copper particles so as to block it from external air by isolating and purifying the copper particles from the second solution and then leaving the copper particles in the air.
